(19) United States
(12) Patent Application Publication
(10) Pub. No.: US 2023/0247422 A1
(43) Pub. Date: Aug. 3, 2023

(54) SECURE MULTI-ENTERPRISE WIRELESS NETWORK

(71) Applicant: Palo Alto Networks, Inc., Santa Clara, CA (US)

(72) Inventor: Ta Chien Lin, Oakland, CA (US)

(21) Appl. No.: 17/649,704

(22) Filed: Feb. 2, 2022

(51) Int. Cl. H04W 12/06

(52) U.S. Cl. CPC H04W 12/06

(57) ABSTRACT

An access point service configures and manages a multi-enterprise wireless network in public settings. During network profile setup for a client connecting to an enterprise-issued access point (e.g., in a home environment), the service determines network information unique to the client and an authentication server associated with the enterprise to which the client is to authenticate for 802.1X authentication and stores the client network information and an indication of the authentication server in a cloud database. For access points in a public setting, upon detection of an association request by a client, the service determines network information that identifies the client and performs a lookup of the cloud database with the network information to determine to which of the recognized authentication servers to forward authentication messages transmitted by the client. If the result of the lookup does not indicate an authentication server, the connection is terminated.

### BACKGROUND

The disclosure generally relates to wireless communication networks and to devices specially adapted for wireless communication networks, e.g., access point devices.

Wi-Fi networks are wireless local area networks (WLANs) which are based on the Institute of Electrical and Electronics Engineers (IEEE) 802.11 technical standards. Wireless access points, also simply referred to as access points, are hardware devices that connect to wired networks (e.g., Ethernet) and provide the wireless connection by which Wi-Fi compatible devices can connect to wired networks. Access points are associated with a basic service set identifier (BSSID) which corresponds to the media access control (MAC) address of the access point and uniquely identifies the access point. A Wi-Fi network provided by an access point is identified or named with a service set identifier (SSID). Generally, an SSID of a Wi-Fi network is broadcast to Wi-Fi compatible devices in range through periodic transmission of beacon frames by the associated access point. Beacon frames include fields for the SSID which identifies the associated Wi-Fi network and other information about the network. Wi-Fi networks for which a device is in range are identified to the device by their respective SSIDs upon receipt of the respective beacon frames. Access points associated with Wi-Fi networks which are hidden (“hidden networks”), however, omit the SSID from the transmitted beacon frames that include other information about the network. As a result, devices attempting to associate with the access point and connect to the Internet via the hidden network should provide the correct SSID of the hidden network to the access point in a probe request frame. If an SSID is not provided or the provided SSID is incorrect, the access point will not respond to the device with a probe response, and the device will be unable to discover the hidden network to initiate and complete authentication to and association with the access point.

Wi-Fi networks, whether hidden or not, can be secured according to various mechanisms, with versions of Wi-Fi Protected Access (WPA) security commonly implemented for WLAN security. Wi-Fi networks can use one of several modes of WPA security for encryption of network traffic, including WPA-Personal and WPA-Enterprise modes. WPA-Personal and WPA-Enterprise can be distinguished in that while networks secured with WPA-Personal security have set a single password that should be provided by any user connecting to the network, with WPA-Enterprise security, users are authenticated based on provided access credentials (e.g., username and password) before a network connection can be established. Users connecting to a WPA-Enterprise-secured network are authenticated according to the IEEE 802.1X authentication standard. IEEE 802.1X defines the encapsulation of the Extensible Authentication Protocol (EAP) authentication framework over IEEE 802, the standard for local area networks (LANs). EAP, which is defined in Request for Comments (RFC) 3748, provides the framework for an authentication exchange between an authenticator, a supplicant, and an authentication server. In the context of 802.1X authentication, these entities generally correspond to an access point, a client, and a Remote Authentication Dial-In User Service (RADIUS) server, respectively. After the client has authenticated to and associated with the access point, EAP authentication messages transmitted by the client are forwarded from the access point to the RADIUS server specified in the network security configuration for authentication of the client to the RADIUS server.

### BRIEF DESCRIPTION OF THE DRAWINGS

Aspects of the disclosure may be better understood by referencing the accompanying drawings.

FIG. 1 is a conceptual diagram of an access point that provides a multi-enterprise wireless network.

FIG. 2 is a conceptual diagram of an access point that provides a multi-enterprise hidden wireless network.

FIG. 3 is a flowchart of example operations for determining an authentication server to which a client attempting connection to a multi-enterprise wireless network is to authenticate.

FIG. 4 is a flowchart of example operations for determining an authentication server to which a client attempting connection to a multi-enterprise hidden wireless network is to authenticate.

FIG. 5 is a conceptual diagram of onboarding a client associated with an enterprise for compatibility with a multi-enterprise wireless network.

FIG. 6 is a flowchart of example operations for onboarding a client for compatibility with a multi-enterprise wireless network.

FIG. 7 depicts an example computer system with a multi-enterprise network configuration service.

### DESCRIPTION

The description that follows includes example systems, methods, techniques, and program flows that embody aspects of the disclosure. However, it is understood that this disclosure may be practiced without these specific details. For instance, this disclosure refers to access points which connect to a router via a wired connection (e.g., with an Ethernet cable) for creation of a WLAN in illustrative examples. Aspects of this disclosure can be instead applied to other hardware configurations by which WLANs can be created, such as wireless routers which comprise an access point. In other instances, well-known instruction instances, protocols, structures and techniques have not been shown in detail in order not to obfuscate the description.

Overview

As an increasing number of employers shift to a work-from-home model, modern security solutions often seek to address the question of how to extend the security provided by the corporate network on-premises to the homes of remotely-located employees. Described herein is a service executing on an access point that configures the access point to provide a multi-enterprise Wi-Fi network secured with WPA-Enterprise security. The network is referred to as “multi -enterprise” because users associated with different enterprises/organizations and therefore different authentication servers for 802.1X authentication can be authenticated with their enterprise credentials to successfully connect to the network. As a result, the security provided by the corporate network is further extended beyond the employee's home environment and into public spaces.

In a home setting, when clients create a network profile during setup of an employer-issued access point having the service executing thereon, the service determines network information unique to the client from messages transmitted by the client. The network information at least includes a MAC address of the client and may also include an SSID of the network for which the network profile is being set up. The service also determines a domain name or IP address of the authentication server to which the client is to authenticate for 802.1X authentication based on a network security configuration provided by the employer. The service stores the network information determined for the client and an indication of the authentication server for subsequent reference, such as in a cloud database that is accessible across access points on which instances of the service executes. As a result, the service has access to associations between network information of clients across enterprises and corresponding indications of authentication servers used by respective ones of the enterprises.

Access points configured with the service can also be located in public settings that provide a public network in addition to the multi-enterprise network (e.g., cafes or libraries). In the public setting, upon detection of an association request transmitted by a client, the service determines network information that uniquely identifies the client based on the association request. The access point can provide the multi-enterprise network as a hidden network or may advertise the availability of the network. If the access point is providing the multi-enterprise network as a hidden network, the network information determined from the association request comprises a MAC address and SSID provided by the client; otherwise, the network information comprises a MAC address. The service performs a lookup with the determined network information on the associations between network information of clients and the corresponding indications of authentication servers. If the client is authorized to connect to the multi-enterprise network, the result of the lookup will identify one of the plurality of authentication servers to which authentication messages should subsequently be forwarded for authentication of the client. If the result of the lookup does not indicate an authentication server and the client thus is not authorized to connect to the multi-enterprise network, the service can terminate the connection or otherwise denote that authentication of the client has failed to prevent further exchange of data for the client.

Example Illustrations

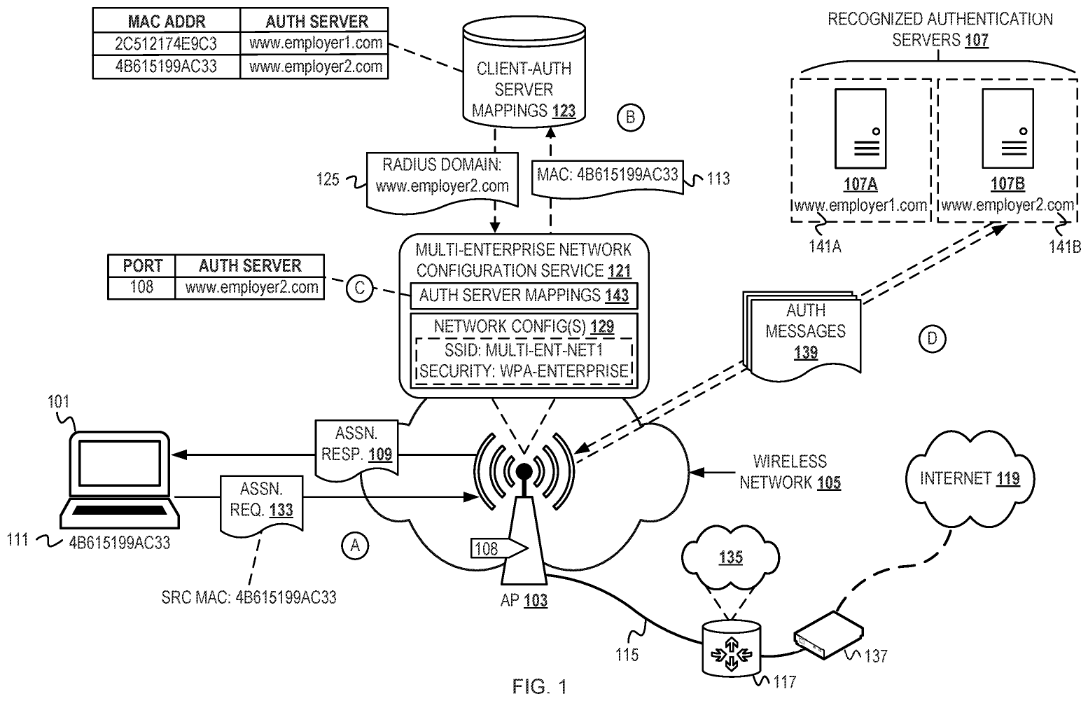

FIG. 1 is a conceptual diagram of an access point that provides a multi-enterprise wireless network. FIG. 1 depicts an access point 103 that creates a wireless network 105, or a WLAN based on the IEEE 802.11 standards, by which Wi-Fi compatible devices can wirelessly connect to a local area network (LAN) 135 which provides for connectivity to the Internet 119. The access point 103 is connected to a router 117 with a cable 115 (e.g., an Ethernet cable), where the router 117 has created the LAN 135. The router 117 is connected to a modem 137 to provide access to the Internet 119 via the LAN 135. While the access point 103 is depicted as a standalone hardware device in this example, implementations may utilize wireless routers having access point functionality. The access point 103 may be located in a public setting that makes available public Wi-Fi in addition to the wireless network 105, such as a cafe, library, etc.; other networks offered by the access point 103 in addition to the wireless network 105 (e.g., a public Wi-Fi network) are omitted from FIG. 1 for clarity.

A multi-enterprise network configuration service (“service”) 121 executes on the access point 103. The service 121 supports configuration of the wireless network 105 as a multi-enterprise wireless network. The wireless network 105 is referred to as a multi-enterprise wireless network because clients associated with different enterprises and thus different authentication servers (e.g., RADIUS servers) can be authenticated according to the 802.1X standard for connection to the wireless network 105. The access point 103 may have been configured with the service 121 through installation of the service 121 on the access point 103. The service 121 can access a configuration 129 of the wireless network 105. The configuration 129 may be a configuration file(s) or other configuration data which the access point 103 downloaded and installed for creation of the wireless network 105. In this example, the configuration 129 specifies an SSID of the wireless network 105 as “MULTI-ENT-NET1” and the security type as WPA-Enterprise.

Typically, because the wireless network 105 is secured as a WPA-Enterprise network, the configuration 129 would also specify an IP address or fully qualified domain name (FQDN) of an authentication server such as a RADIUS server to which clients connecting to the wireless network 105 are to authenticate. However, the authentication server which should be employed for authentication of clients connecting to the wireless network 105 can vary depending on the enterprise with which the clients attempting to connect to the wireless network 105 are associated. The configuration 129 thus does not specify a single authentication server, and the service 121 instead determines which of a set of recognized authentication servers 107 should be leveraged for client authentication as is now described.

FIG. 1 is annotated with a series of letters A-D. These letters represent stages of operations. Although these stages are ordered for this example, the stages illustrate one example to aid in understanding this disclosure and should not be used to limit the claims. Subject matter falling within the scope of the claims can vary with respect to the order and some of the operations. The stages of operations are described as beginning at association of a client 101 with the access point 103 for clarity with the assumption that the device has discovered the wireless network 105 (e.g., through transmission of a probe request frame indicating the SSID of the wireless network 105) and authenticated to the access point 103. The access point 103 has allocated port 108 for communications from the client 101 (e.g., through allocation of a logical port of the access point 103).

At stage A, the service 121 detects an association request 133 transmitted from the client 101 and determines a MAC address of the client 101 based on the association request 133. The client 101 can be any Wi-Fi compatible device and has a MAC address 111 assigned to its network interface controller (NIC). The association request 133 that is transmitted to the access point 103 comports to the association request frame format per WLAN protocol. The association request 133 includes the MAC address 111 of the client 101 (e.g., in its MAC header as the source address). The service 121 extracts (e.g., copies) the MAC address 111 from the association request 133. The access point 103 transmits an association response 109 to the client 101 so that the client 101 is associated to the access point 103. However, the access point 103 sets the state of port 108 allocated for the connection with the client 101 as “unauthorized” due to the client 101 not completing WPA-Enterprise authentication that is a prerequisite for connecting to the wireless network 105. The client 101 is unable to transmit data over the Internet 119 via the wireless network 105 until authenticating to one of the recognized authentication servers 107 so the state of port 108 can subsequently be set to “authorized.”

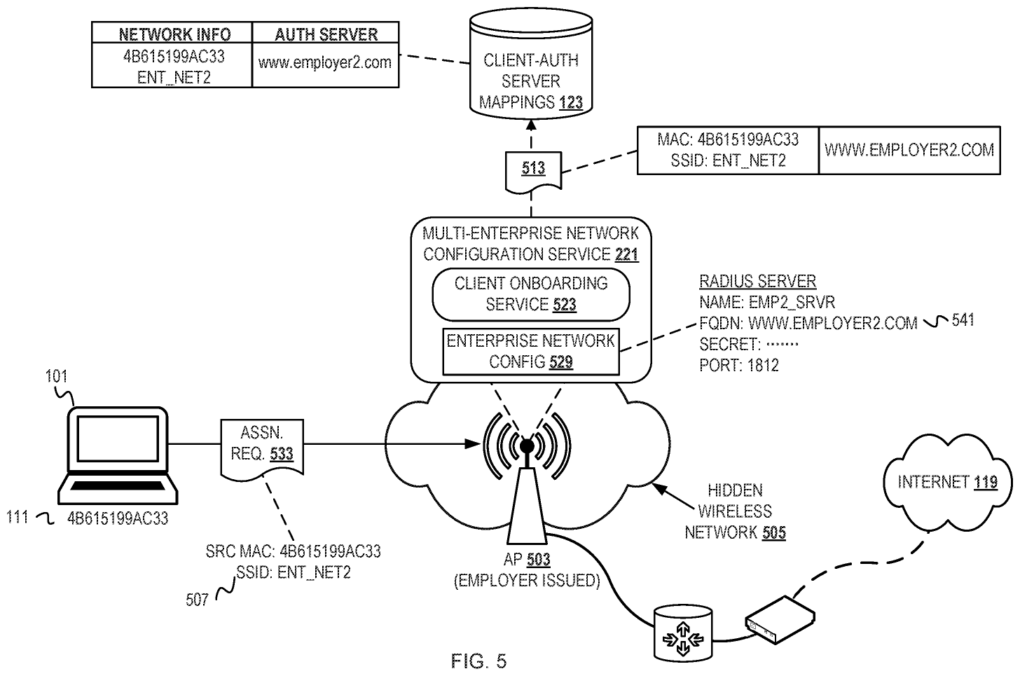

At stage B, the service 121 performs a lookup for the MAC address 111 in a repository 123 of mappings between MAC addresses associated with clients and indications of corresponding ones of the recognized authentication servers 107. The indications of the authentication servers may be IP addresses and/or FQDNs of the authentication servers. The repository 123 is a cloud database that stores MAC addresses and corresponding indications of authentication servers that were previously determined for clients (as is described in reference to FIG. 5). Clients having a MAC address in association with an IP address or FQDN of one of the recognized authentication servers 107 stored in the repository 123 are thus able to connect to the wireless network 105 upon successful authentication. While the service 121 is depicted as accessing a cloud database to perform the lookup in this example, the associations stored in the repository 123 may be stored locally on the access point 103 and accessible to the service 121 in other examples.

The repository 123 has stored a MAC address of a first client in association with a FQDN 141A of an authentication server 107A and the MAC address 111 of the client 101 in association with a FQDN 141B of an authentication server 107B. The recognized authentication servers 107 thus includes the authentication server 107A and authentication server 107B. The service 121 communicates a request 113 to the repository 123 that indicates the MAC address 111 of the client 101 and obtains a result 125. The service 121 determines whether the result 125 indicates an authentication server known to be associated with the MAC address 111 and whether the client 101 thus can connect to the wireless network 105 (assuming successful authentication). In this example, because the MAC address 111 is stored in the repository 123 in association with the FQDN 141B of the authentication server 107B, the result 125 returned in response to the request 113 indicates the FQDN 141B of the authentication server 107B to which the client 101 is to authenticate.

At stage C, the service 121 designates the FQDN 141B as the location of the authentication server that should be the recipient of subsequent authentication messages sent from the client 101 as part of the EAP authentication exchange. Designating the FQDN 141B as the location of the authentication server corresponding to the client 101 may be achieved through updating authentication server mappings 143 maintained by the service 121 that comprise mappings between indications of clients that have authenticated to and associated with the access point 103 and the corresponding authentication servers determined based on MAC address lookups. In this example, the authentication server mappings 143 comprise port numbers that the access point 103 has allocated to clients and corresponding FQDNs or IP addresses of authentication servers that have been determined for the clients. The service 121 updates the authentication server mappings 143 with an association between port 108 and the FQDN 141B. However, in other examples, the authentication server mappings 143 can comprise different information that maps indications of clients to corresponding authentication servers (e.g., lookup keys that produce indications of authentication servers as results). As a result, the service 121 can subsequently determine that authentication messages received on port 108 should be relayed to the authentication server 107B for completion of an EAP authentication exchange.

At stage D, the service 121 forwards subsequent authentication messages 139 transmitted by the client 101 to the authentication server 107B for completion of authentication of the client 101 per the WPA-Enterprise mode that is implemented for securing the wireless network 105. For instance, the version of WPA-Enterprise by which the wireless network 105 is secured may use EAP-Transport Layer Security (TLS) for client authentication. The authentication messages 139 thus may comprise messages transmitted over an encrypted connection according to the EAP-TLS standard for authentication. For example, the service 121 forwards access credentials (e.g., username and password) supplied by the client 101 to the authentication server 107B over an encrypted connection between the client 101 and the authentication server 107B per the EAP-TLS standard to determine whether the access credentials can be verified. If the client 101 is successfully authenticated, the access point 103 updates state of port 108 corresponding to the connection with the client 101 to an “authorized” state, and the client 101 can transmit data over the Internet 119 via the wireless network 105.

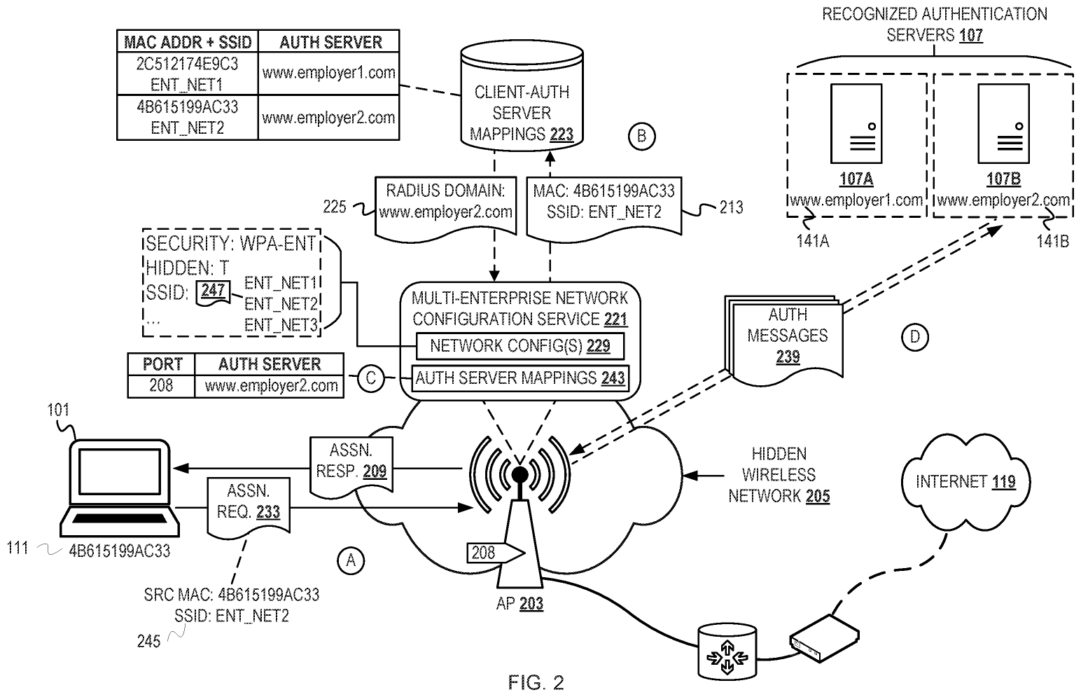

FIG. 2 is a conceptual diagram of an access point that provides a multi-enterprise hidden wireless network. FIG. 2 depicts an access point 203 having a hardware configuration similar to that of FIG. 1 that allows for Wi-Fi compatible devices to access the Internet 119. Like the access point 103, the access point 203 is depicted as a standalone hardware device; however, implementations may utilize wireless routers having access point functionality. In this example, the access point 203 provides a wireless network that has been configured as a hidden network 205—that is, beacon frames transmitted by the access point 203 for the hidden network 205 omit SSID information associated with the hidden network 205. The access point 203 may be located in a public setting that makes available public Wi-Fi in addition to the hidden network 205 so that those wishing to utilize the multi-enterprise network rather than the public network are to first provide an SSID of the hidden network 205 when discovering its availability.

A multi-enterprise network configuration service (“service”) 221 executes on the access point 203. The access point 103 may have been configured with the service 221 through installation of the service 221 on the access point 203. The service 221 is another implementation of a service for configuring and supporting a wireless network offered by an access point as a multi-enterprise wireless network but configures the multi-enterprise wireless network as a hidden network. The service 221 thus supports configuration of the hidden network 205 as a multi-enterprise hidden network.

In some examples such as that depicted in FIG. 2, the hidden network 205 is discoverable with multiple SSIDs to provide a one-to-many mapping between the hidden network 205 and the SSIDs by which the hidden network 205 can be discovered. The service 221 can access a configuration 229 of the hidden network 205. The configuration 229 may be a configuration file(s) or other configuration data which the access point 203 downloaded and installed for creation of the hidden network 205. The configuration 229 depicts an example configuration of the hidden network 205 that indicates that the property “hidden” is set to “true” for the provided wireless network as well as a set of supported SSIDs (“SSID set”) 223 with which the access point has been configured. The SSID set 247 comprises one or more SSIDs which have been defined for the hidden network 205. In this example, since there are multiple SSIDs indicated in the SSID set 247, any SSID in the SSID set 247 can be used for connecting to the hidden network 205. The SSID set 247 may be a data structure maintained by the service 221. In this example, the SSID set 247 at least includes SSIDs of “ENT NET1,” “ENT NET2,” and “ENT NET3.”

FIG. 2 is annotated with a series of letters A-D. These letters represent stages of operations. Although these stages are ordered for this example, the stages illustrate one example to aid in understanding this disclosure and should not be used to limit the claims. Subject matter falling within the scope of the claims can vary with respect to the order and some of the operations. As with FIG. 1, the stages of operations are described as starting with association of the client 101 with the access point 203 for clarity with the assumption that the device has already discovered the hidden network 205 through transmission of a probe request frame indicating one of the SSIDs of the SSID set 223 by which the hidden network 205 is discoverable and authenticated to the access point 203. The access point 203 has allocated port 208 for communications from the client 101 (e.g., through allocation of a logical port).

At stage A, the service 221 detects an association request 233 transmitted from the client 101 and determines a MAC address of the client 101. The association request 233 that is transmitted to the access point 203 comports to the association request frame format per WLAN protocol. The association request 233 includes the MAC address 111 of the client 101 and an SSID 245 supplied by the client 101, where the SSID 245 is one included in the SSID set 247. The service 221 extracts (e.g., copies) the MAC address 111 and SSID 245 from the association request 233. The access point 103 transmits an association response 209 to the client 101 so that the client 101 is associated to the access point 203. However, the access point 203 sets the state of port 208 allocated for the connection with the client 101 as “unauthorized” due to the client 101 not completing WPA-Enterprise authentication as enforced by the access point 203 for the hidden network 205. The client 101 is unable to transmit data over the Internet 119 via the hidden network 205 until authenticating to one of the recognized authentication servers 107 so the state of port 208 can subsequently be set to “authorized.”

At stage B, the service 221 performs a lookup for the MAC address 111 and SSID 245 in a repository 223 of mappings between MAC address-SSID pairs associated with clients and indications of corresponding ones of the recognized authentication servers 107. The repository 223 is a cloud database that stores pairs of MAC addresses and SSIDs and corresponding FQDNs of authentication servers that were previously determined for clients (as is described in reference to FIG. 5). Clients having a MAC address/SSID pair and an indication of corresponding one of the recognized authentication servers 107 stored in the repository 223 are thus able to connect to the hidden network 205 upon successful authentication. Clients should therefore consistently supply the same SSID as was used during client onboarding (e.g., an SSID assigned to the client by the corresponding enterprise) when attempting to connect to a multi-enterprise hidden wireless network. While the service 221 is depicted as accessing a cloud database to perform the lookup in this example, the associations stored in the repository 223 may be stored locally on the access point 203 and accessible to the service 221 in other examples.

The repository 223 has stored a MAC address and SSID for a first client in association with the FQDN 141A of an authentication server 107A and the MAC address 111 and SSID 245 for the client 101 in association with the FQDN 141B of an authentication server 107B. The service 221 communicates a request 213 to the repository 223 that indicates the MAC address 111 and SSID 245 determined for the client 101 and obtains a result 225. The service 221 determines whether the result 225 indicates an authentication server known to be associated with the pair comprising the MAC address 111 and SSID 245 and determines whether the client 101 thus can connect to the hidden network 205 (assuming successful authentication). In this example, because the pair comprising the MAC address 111 and the SSID 245 is stored in the repository 223 in association with the FQDN 141B of the authentication server 107B, the result 225 returned in response to the request 213 indicates the FQDN 141B of the authentication server 107B to which the client 101 is to authenticate.

At stage C, the service 221 designates the FQDN 141B as the location of the authentication server that should be the recipient of subsequent authentication messages sent from the client 101 as part of the EAP authentication exchange. Designating the FQDN 141B as the location of the authentication server corresponding to the client 101 may be achieved through updating authentication server mappings 243 maintained by the service 221 that comprise mappings between clients that have authenticated to and associated with the access point 203 and the corresponding authentication servers determined based on MAC address lookups. In this example, the authentication server mappings 243 comprise port numbers that have been allocated to clients by the access point 203 and corresponding FQDNs or IP addresses of authentication servers that have been determined for the clients; in other examples, however, clients may be mapped to authentication servers otherwise (e.g., via lookup keys/hashing that produces indications of authentication servers as results). The service 221 updates the authentication server mappings 243 with an association between port 208, which has been allocated for the client 101, and the FQDN 141B. As a result, the service 221 can subsequently determine that authentication messages received on port 208 should be relayed to the authentication server 107B for completion of an EAP authentication exchange.

At stage D, the service 221 forwards subsequent authentication messages 239 transmitted by the client 101 to the authentication server 107B for completion of authentication of the client 101 per the WPA-Enterprise mode that is implemented for securing the hidden network 205. For instance, the version of WPA-Enterprise by which the hidden network 205 is secured may use EAP-TLS for client authentication. The authentication messages 239 thus may comprise messages transmitted over an encrypted connection according to the EAP-TLS standard for authentication. For example, the service 221 forwards access credentials (e.g., username and password) supplied by the client 101 to the authentication server 107B over an encrypted connection between the client 101 and the authentication server 107B per the EAP-TLS standard to determine whether the access credentials can be verified. If the client 101 is successfully authenticated, the access point 203 updates the state of port 208 corresponding to the connection with the client 101 to an “authorized” state, and data can then be transmitted over the Internet 119 via the hidden network 205.

In some implementations, as new enterprises opt to provide their employees with access to the multi-enterprise hidden network, the SSID set 247 should be updated with new SSIDs used to identify the hidden network. In this case, access points such as the access point 203 may periodically download and install updates to the configuration 229 that indicate an update to the SSID set 247. The update may indicate one or more additional SSIDs that correctly identify the hidden network 205 and thus may also be maintained in the repository 223 in association with a MAC address and an authentication server IP address/FQDN. Periodically “refreshing” the SSID set 247 across access points in implementations that provide the multi-enterprise network as a hidden network allows for the employees of the newly-supported enterprise to seamlessly connect to the multi-enterprise network without manual configuration.

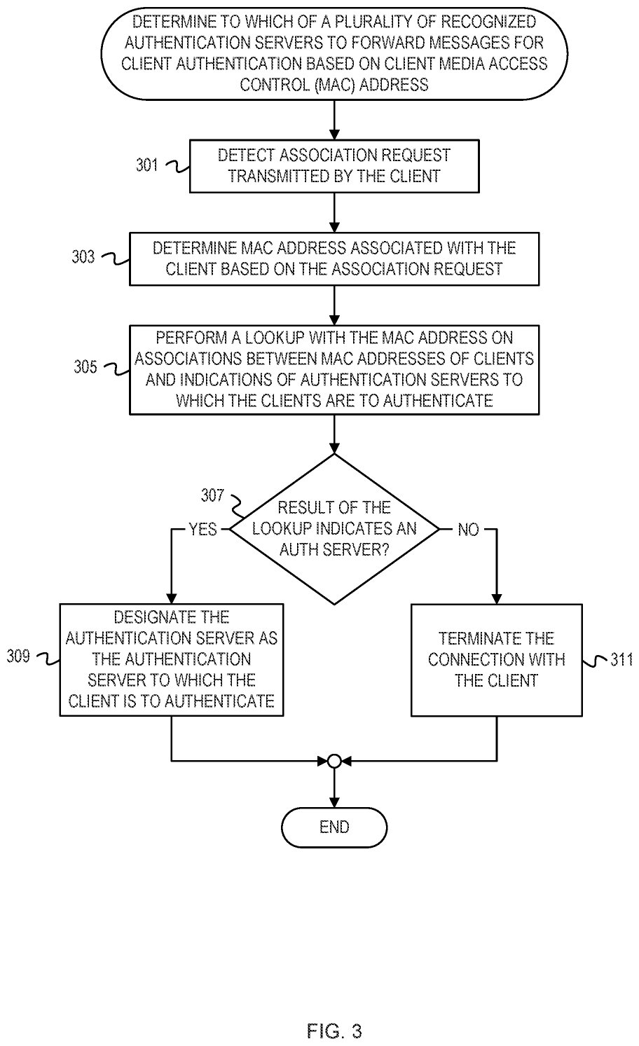

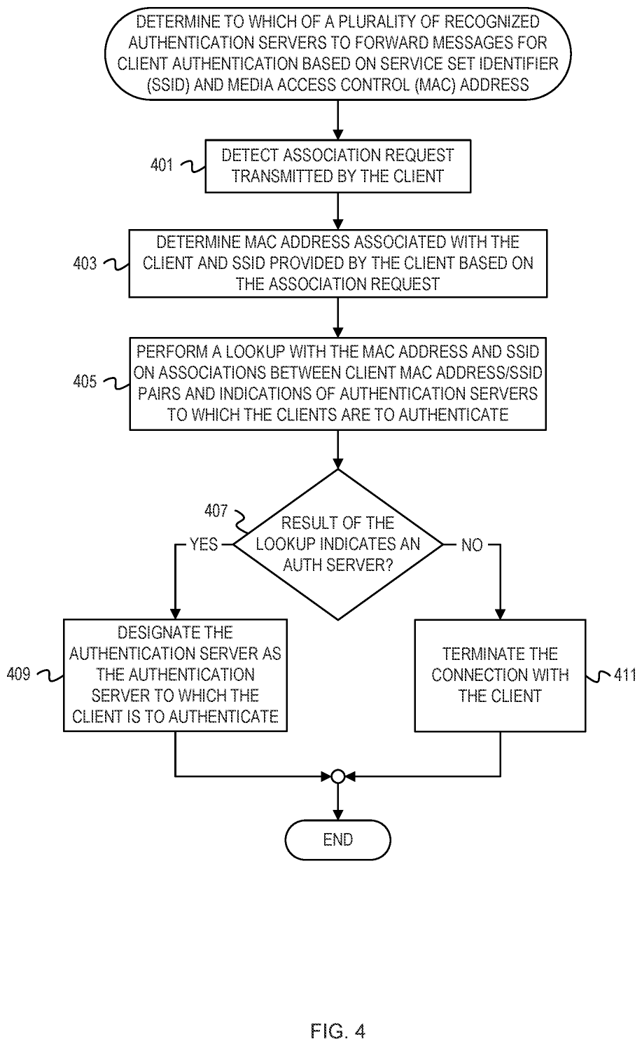

FIGS. 3 and 4 are flowcharts of example operations for facilitating client authentication for establishing connections to a multi-enterprise wireless network. The example operations are described with reference to a multi-enterprise network configuration service (hereinafter “the service”) for consistency with the earlier figures. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for determining an authentication server to which a client attempting connection to a multi-enterprise wireless network is to authenticate. The example operations begin with association of a client with an access point after the client has discovered availability of a multi-enterprise network and authenticated to the access point as part of the 802.11 association process (e.g., based on transmittal of probe request/response and authentication frames).

At block 301, the service detects an association request transmitted by the client. The association request is an association request frame formatted according to WLAN protocol that includes a MAC header and frame body. The service can detect the association request based on receipt of the association request frame by the access point on which the service executes. Subsequent determination of whether to accept the association request and transmission of an association response to the client by the access point (assuming the association request is accepted) such that the client is associated with the access point may occur prior to completion of the subsequent example operations or in parallel or concurrently with the subsequent example operations.

At block 303, the service determines a MAC address associated with the client based on the association request. Frames formatted according to 802.11 WLAN protocol such as the frame by which the association request was communicated comprise a transmitter address field in the MAC header. The MAC address associated with the client is indicated in this transmitter address field of the MAC header of the received association request. The service can determine the MAC address from the association request based on the format of 802.11 WLAN frames (e.g., based on known offsets/indices).

At block 305, the service performs a lookup with the MAC address on associations between MAC addresses of clients and indications of authentication servers to which the clients are to authenticate. The service has access to associations between client MAC addresses and, for each MAC address, an indication of an authentication server to which the corresponding client should authenticate for 802.1X authentication. The indications of authentication servers may be IP addresses or FQDNs of RADIUS servers used by various enterprises for 802.1X authentication of employees. The associations may be stored in a cloud database accessible to the service or, in other examples, may be installed on the access point or stored in a data structure accessible to the service. The service performs a lookup on the associations with the MAC address of the client determined from the association request (e.g., by searching the associations for the MAC address, querying the cloud database which maintains the associations with the MAC address, etc.).

At block 307, the service determines if a result of the lookup indicates an authentication server. If the MAC address determined for the client is stored in the associations between known client MAC addresses and corresponding authentication servers, the result of the lookup will indicate an authentication server (e.g., a FQDN/IP address of a RADIUS server) to which the client is to authenticate. If the result indicates an authentication server, operations continue at block 309. Otherwise, the MAC address is absent from the MAC address-authentication server associations, and operations continue at block 311.

At block 309, the service designates the authentication server as that to which the client is to authenticate. The service may maintain mappings between indications of clients and domain names/IP addresses of authentication servers to which each of the clients is to authenticate (e.g., via lookup keys). In this case, the service can designate the authentication server by updating the mappings to include a mapping between an indication of the client and the indication of the authentication server determined from the result of the lookup. As a result, the service can forward subsequent authentication messages transmitted by the client and received by the access point on the respective port to the appropriate authentication server.

At block 311, the service terminates the connection with the client. Terminating communications with the client can include terminating the connection established between the access point and the client and/or communicating an authentication failure to the client. The service may terminate the connection by initiating transmission of a deauthentication frame from the access point to the client, which will prompt de-authentication of the client to and disassociation of the client from the access point. As another example, if EAP-TLS is designated as the authentication framework to be used for 802.1X authentication, a default server certificate may be provided to the client for the server certificate validation performed as part of EAP-TLS. The default server certificate may correspond to a server having a same owner as the service, such as the same security provider.

Upon communication of the default server certificate to the client, the client can provide authentication credentials suitable for the designated authentication framework. Because the MAC address lookup failed, after collection of credentials from the client, an authentication failure is communicated to the client because the client is not designated as compatible with the wireless network via the associations between known client MAC addresses and corresponding authentication servers. The authentication failure that ultimately results would thus appear to the client as being a result of incorrect authentication credentials rather than the failed MAC address lookup, so the MAC address-based lookup underlying the authentication failure is not revealed to the user.

FIG. 4 is a flowchart of example operations for determining an authentication server to which a client attempting connection to a multi-enterprise hidden wireless network is to authenticate. The example operations assume that a repository comprising at least one client MAC address/SSID pair and associated authentication server exists and is accessible to the service (e.g., by being maintained in a cloud). The example operations begin with association of a client with an access point after the client has discovered availability of a multi-enterprise hidden network with an SSID that correctly identifies the network and authenticated to the access point as part of the 802.11 association process (e.g., based on transmittal of probe request/response and authentication frames).

At block 401, the service detects an association request transmitted by the client. The association request is an association request frame formatted according to WLAN protocol that includes a MAC header and frame body. The service can detect the association request based on receipt of the association request frame by the access point on which the service executes. Subsequent determination of whether to accept the association request and transmission of an association response to the client by the access point (assuming the association request is accepted) such that the client is associated with the access point may occur prior to completion of the subsequent example operations or in parallel or concurrently with the subsequent example operations.

At block 403, the service determines a MAC address associated with the client and an SSID provided by the client based on the association request. Frames formatted according to 802.11 WLAN protocol such as the frame by which the association request was communicated comprise a transmitter address field in the MAC header. The MAC address associated with the client is indicated in this transmitter address field of the MAC header of the association request, while the SSID is indicated in the frame body. The service can determine the MAC address and SSID from the association request based on the format of 802.11 WLAN frames (e.g., based on known offsets/indices).

At block 405, the service performs a lookup with the MAC address and the SSID on associations between MAC address/SSID pairs and indications of authentication servers to which clients corresponding to the MAC address/SSID pairs are to authenticate. The service has access to associations between pairs of MAC addresses and SSID and, for each MAC address/SSID pair, an indication of an authentication server to which the corresponding client should authenticate for 802.1X authentication. The indications of authentication servers may be IP addresses or FQDNs of RADIUS servers used by various enterprises for 802.1X authentication of employees. The associations may be stored in a cloud database accessible to the service or, in other examples, may be installed on the access point or stored in a data structure accessible to the service. The service performs a lookup on the associations with the MAC address and SSID determined from the association request (e.g., by searching the associations for the MAC address and SSID pair, querying the cloud database which maintains the associations with the MAC address and SSID pair, etc.).

At block 407, the service determines if a result of the lookup indicates an authentication server. If the pair comprising the MAC address and SSID determined for the client is stored in the associations between known client MAC addresses/SSIDs and corresponding authentication servers, the result of the lookup will indicate an authentication server (e.g., a FQDN/IP address of a RADIUS server) to which the client is to authenticate. If the result indicates an authentication server, operations continue at block 409. Otherwise, the MAC address/SSID pair is absent from the associations between MAC address/SSID pairs and authentication servers, and operations continue at block 411.

At block 409, the service designates the authentication server as that to which the client is to authenticate. The service may maintain mappings between indications of clients and domain names/IP addresses of authentication servers to which each of the clients is to authenticate. In this case, the service can designate the authentication server by updating the mappings to include a mapping between the indication of the client and the indication of the authentication server determined from the result of the lookup. As a result, the service can forward subsequent authentication messages transmitted by the client and received by the access point on the respective port to the appropriate authentication server.

At block 411, the service terminates the connection with the client. Terminating communications with the client can include terminating the connection established between the access point and the client and/or communicating an authentication failure to the client. The service may terminate the connection by initiating transmission of a deauthentication frame from the access point to the client, which will prompt de-authentication of the client to and disassociation of the client from the access point. As another example, if EAP-TLS is designated as the authentication framework to be used for 802.1X authentication, a default server certificate may be provided to the client for the server certificate validation performed as part of EAP-TLS. The default server certificate may correspond to a server having a same owner as the service.

Upon communication of the default server certificate to the client, the client can provide authentication credentials suitable for the designated authentication framework. Because the MAC address/SSID lookup failed, after collection of credentials from the client, an authentication failure is communicated to the client because the client is not designated as compatible with the wireless network via the associations between known client MAC addresses/SSIDs and corresponding authentication servers. The authentication failure that ultimately results would thus appear to the client as being a result of incorrect authentication credentials rather than the failed MAC address/SSID lookup, so the MAC address/SSID-based lookup underlying the authentication failure is not revealed to the user.

FIG. 5 is a conceptual diagram of onboarding a client associated with an enterprise for compatibility with a multi-enterprise wireless network. FIG. 5 depicts an access point 503 that has been issued to an employee associated with the client 101 (e.g., to provide enterprise security in a work-from-home arrangement). The access point 503 provides a hidden network 505 via which the client can access the Internet 119 as similarly described in reference to FIGS. 1 and 2. FIG. 5 depicts the initial onboarding of the client 101 by the service 221 that executes on the access point 503 in a home environment so that the client 101 can utilize a multi-enterprise wireless network in a public setting as described above. In other words, the service 221 contributes to building of the repository 123 as clients are onboarded as part of setup of an access point issued by their employer that has opted to issue an access point having the service 221 installed thereon. The service 121 or service 221 can be installed on employer-issued access points depending on whether the multi-enterprise wireless network that will be offered to employees will be hidden or visible. This example refers to the service 221 onboarding the client 101 for compatibility with a multi-enterprise hidden wireless network as described in reference to FIG. 2.

The client 101 transmits an association request 533 to the access point 503 after discovering the availability of the hidden network 505 by providing an SSID that correctly identifies the hidden network 505 and authenticating to the access point 503. The association request 533 is an association request frame that comprises network information 507. The network information 507 includes the MAC address 111 of the client 101 and an SSID provided by the client 101 that identifies the hidden network 505. A client onboarding service 523 that executes on the service 221 determines the network information 507 based on the association request 533. The client onboarding service 523 may determine the network information 507 based on corresponding fields of the association request frame (e.g., the source address field in the MAC header and the SSID field in the frame body).

The client onboarding service 523 determines the authentication server to which the client 101 is to authenticate for WPA-Enterprise security based on an enterprise network configuration (“configuration”) 529 installed on the access point 503 and made accessible to the service 221. The configuration 529 indicates a security configuration of the hidden network 505 so that the hidden network 505 is secured with WPA-Enterprise security. The configuration 529 comprises an indication of the RADIUS server associated with the enterprise that issued the access point 503, which in this example is a FQDN 541 of the RADIUS server. The FQDN 541 of the RADIUS server to which the client 101 is to authenticate is already installed on the access point 503 because the access point 503 is associated with the organization for which the client 101 should be completing authentication for WPA-Enterprise security. The client onboarding service 523 determines the FQDN 541 of the RADIUS server corresponding to the client 101 based on the configuration 529. The client 101 can then authenticate against the RADIUS server indicated in the configuration 529.

An association 513 between the network information 507 and the FQDN 541 is inserted into the repository 123 based on successful authentication of the client 101. The association 513 may be inserted into the repository 123 by the client onboarding service 523 upon authentication of the client 101 or during initial device configuration/setup (e.g., during initial setup of the client 101 with the enterprise network, such as by or with the assistance of an information technology or network administrator). As a result, subsequent lookups for the network information 507 in the repository 123 by access points located in public settings will return the FQDN 541 associated with the client 101. The client 101 can thus connect to multi-enterprise hidden networks offered by access points in public settings having the service 221 executing thereon.

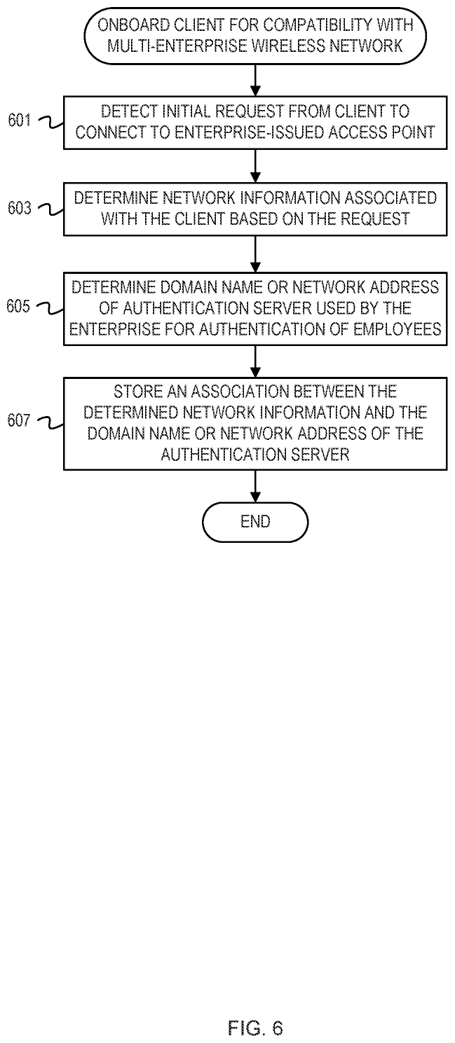

FIG. 6 is a flowchart of example operations for onboarding a client for compatibility with a multi-enterprise wireless network. Like the example operations of FIGS. 3 and 4, the example operations of FIG. 6 are described with reference to a multi-enterprise network configuration service (hereinafter “the service”) for consistency with the earlier figures. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

At block 601, the service detects an initial request from a client to connect to an enterprise-issued access point. The initial request may be a probe request frame broadcast by the client during setup of a network profile. The service can thus detect the initial request based on receipt of the probe request frame by the access point. The remainder of the example operations assume that the access point on which the service executes for performance of client onboarding operations has a network configuration installed thereon which specifies a RADIUS server or other authentication server used by an enterprise with which the client is associated. For instance, the access point may have a network configuration installed thereon by the issuing enterprise which indicates that the wireless network provided by the access point will be secured with WPA-Enterprise security and specifies an IP address or FQDN of a RADIUS server that will be utilized for WPA-Enterprise authentication.

At block 603, the service determines network information associated with the client based on the request. The network information can be a MAC address assigned to the NIC of the client or the MAC address and the SSID indicated in the request. The service determines the network information based on values indicated in the request, such as based on fields of the probe request frame that correspond to the MAC address or the MAC address and SSID. Whether the service determines the MAC address or the SSID in addition to the MAC address may be a configurable setting of the service or may be based on whether the wireless network provided by the access point is a hidden network or is visible (e.g., as indicated in the Wi-Fi network configuration installed on the access point).

At block 605, the service determines a domain name or IP address of the authentication server used by the enterprise for authentication of employees. The service can determine a FQDN or IP address of an authentication server, generally a RADIUS server, used by the enterprise for network security. The domain name or IP address may be determined from a network configuration installed on the access point and made accessible to the service, where the network configuration specifies a WPA-Enterprise security configuration for the network.

At block 607, the service stores an association between the determined network information and the indication of the authentication server. The service maintains or has access to a plurality of associations between network information determined for clients and corresponding indications of authentication servers (e.g., IP addresses/FQDNs of RADIUS servers). For instance, the associations may be stored in a cloud database or on a cloud server that is accessible to the service.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIGS. 3 and 4 can be performed in parallel or concurrently across clients. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

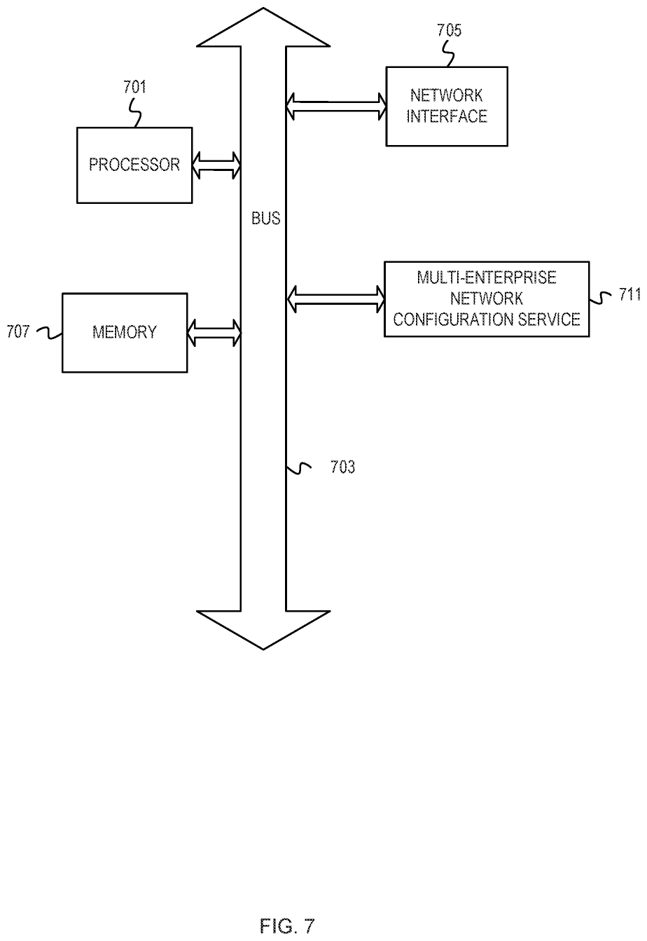

FIG. 7 depicts an example computer system with a multi-enterprise network configuration service. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes multi-enterprise network configuration service 711. The multi-enterprise network configuration service 711 configures a wireless network, which may be visible or hidden across implementations, as a WPA-Enterprise secured network to which clients across supported enterprises can connect based on mapping network information of clients to recognized authentication servers. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

While the aspects of the disclosure are described with reference to various implementations and exploitations, it will be understood that these aspects are illustrative and that the scope of the claims is not limited to them. In general, techniques for configuration of a secure wireless network to which users across different enterprises can connect through authentication with their enterprise credentials as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Terminology

This description uses shorthand terms related to cloud technology for efficiency and ease of explanation. When referring to “a cloud,” this description is referring to the resources of a cloud service provider. For instance, a cloud can encompass the servers, virtual machines, and storage devices of a cloud service provider. In more general terms, a cloud service provider resource accessible to customers is a resource owned/manage by the cloud service provider entity that is accessible via network connections. Often, the access is in accordance with an application programming interface or software development kit provided by the cloud service provider.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
detecting, by a network device which makes available a wireless network, a first request transmitted by a first device;
determining first network information associated with the first device based on the first request;
performing a first lookup with the first network information on associations between network information associated with devices and indications of a plurality of authentication servers corresponding to the devices;
determining if a result of the first lookup indicates one of the plurality of authentication servers; and
based on determining that the result of the first lookup indicates a first of the plurality of authentication servers, forwarding authentication messages subsequently transmitted by the first device to the first authentication server.

2. The method of claim 1, wherein determining the first network information comprises determining a media access control (MAC) address associated with the first device indicated in the first request.

3. The method of claim 2, wherein performing the first lookup comprises performing a lookup with the MAC address on associations between MAC addresses and indications of the plurality of authentication servers.

4. The method of claim 1, wherein the wireless network is a hidden wireless network.

5. The method of claim 4, wherein determining the first network information comprises determining from the first request an SSID provided by the first device and a MAC address associated with the first device.

6. The method of claim 5, wherein performing the first lookup comprises performing a lookup with the SSID and the MAC address on associations between the indications of the plurality of authentication servers and pairs of MAC addresses and SSIDs.

7. The method of claim 1 further comprising, based on determining that the result does not indicate one of the plurality of authentication servers, terminating a connection between the network device and the first device.

8. The method of claim 1, wherein the network device comprises an access point, and wherein the first request comprises an association request.

9. The method of claim 1 further comprising, detecting a second request transmitted by a second device that is different from the first device;
determining second network information based on the second request;
based on performing a second lookup with the second network information on the associations, determining if a result of the second lookup indicates one of the plurality of authentication servers; and
based on determining that the result of the second lookup indicates a second of the plurality of authentication servers, forwarding authentication messages subsequently transmitted by the second device to the second authentication server, wherein the second authentication server is different from the first authentication server.

10. One or more non-transitory machine-readable media having program code stored thereon, the program code comprising instructions to:
detect, by a network device which makes available a wireless network, a first request transmitted by a first client;
determine a first media access control (MAC) address associated with the first client based on the first request;
perform a lookup with the first MAC address on associations between MAC addresses of clients and authentication servers to which the clients are to authenticate for enterprise authentication;
determine whether a result of the lookup indicates one of the authentication servers to which the first client corresponds; and
based on a determination that the result of the lookup indicates a first of the authentication servers, designate the first authentication server for forwarding of authentication messages subsequently transmitted by the first client.

11. The non-transitory machine-readable media of claim 10, wherein the wireless network is a hidden wireless network, and wherein the instructions to determine the first MAC address further comprise instructions to determine a first service set identifier (SSID) indicated in the first request.

12. The non-transitory machine-readable media of claim 11, wherein the associations further comprise SSIDs corresponding to each of the MAC addresses of the clients, and wherein the instructions to perform the lookup comprise instructions to perform the lookup with the first MAC address and the first SSID on associations between pairs of the MAC addresses and the SSIDs of the clients and the authentication servers to which the clients are to authenticate for enterprise authentication.

13. The non-transitory machine-readable media of claim 10 further comprising instructions to, based on a determination that the result of the lookup does not indicate one of the authentication servers, terminate communication with the first client.

14. The non-transitory machine-readable media of claim 10, wherein the first request comprises an association request, and wherein the instructions to determine the first MAC address comprise instructions to determine the first MAC address from the association request.

15. An access point comprising:
a processor; and
a computer-readable medium having instructions stored thereon that are executable by the processor to cause the access point to, detect a first request transmitted by a first client device;
determine first network information associated with the first client device based on the first request;
perform a lookup with the first network information on associations between network information associated with client devices and indications of a plurality of authentication servers corresponding to the client devices, wherein a result of the lookup indicates a first of the plurality of authentication servers; and
forward authentication messages subsequently transmitted by the first client device to the first authentication server.

16. The access point of claim 15, wherein the instructions executable by the processor to cause the access point to determine the first network information comprise instructions executable by the processor to cause the access point to determine a media access control (MAC) address associated with the first client device from the first request.

17. The access point of claim 16, wherein the instructions executable by the processor to cause the access point to perform the lookup comprise instructions executable by the processor to cause the access point to perform a lookup with the MAC address on associations between MAC addresses and indications of the plurality of authentication servers.

18. The access point of claim 15, wherein the access point makes available a hidden wireless network, and wherein the instructions executable by the processor to cause the access point to determine the first network information comprise instructions executable by the processor to cause the access point to determine from the first request a service set identifier (SSID) provided by the first client device and a MAC address associated with the first client device.

19. The access point of claim 18, wherein the instructions executable by the processor to cause the access point to perform the lookup comprise instructions executable by the processor to cause the access point to perform a lookup with the SSID and the MAC address on associations between the indications of the plurality of authentication servers and pairs of MAC addresses and SSIDs.

20. The access point of claim 15 further comprising instructions executable by the processor to cause the access point to:
based on detection of a second request transmitted by a second client device, determine second network information associated with the second client device based on the second request;
perform a lookup with the second network information on the associations, wherein a result of the lookup indicates a second of the plurality of authentication servers different from the first authentication server; and
forward authentication messages subsequently transmitted by the second client device to the second authentication server.
